(19) United States
(12) Patent Application Publication
(10) Pub. No.: US 2026/0002866 A1
(43) Pub. Date: Jan. 1, 2026

(54) ELECTROCHEMICAL TESTING DEVICE

(71) Applicant: University of Science and Technology Beijing, Beijing (CN)

(72) Inventors: Lingwei MA, Beijing (CN); Dawei Zhang, Beijing (CN); Jinke Wang, Beijing (CN); Zhibin Chen, Beijing (CN)

(21) Appl. No.: 18/909,676

(22) Filed: Oct. 8, 2024

(30) Foreign Application Priority Data
Jun. 26, 2024 (CN) 202410833245.6

(51) Int. Cl. G01N 17/02

(52) U.S. Cl. CPC G01N 17/02

(57) ABSTRACT

The present disclosure provides an electrochemical testing device, including: a working platform mounted with a mechanical arm, a test piece tray, a cup cover bracket and an electrochemical testing assembly. The electrochemical testing assembly includes a solution cup including a liquid through hole at a bottom, a reference electrode, an auxiliary electrode, a working electrode test piece, a test piece pallet and a columnar copper wire. The columnar copper wire lifts up the working electrode test piece to press and seal it on the liquid through hole. A cup cover of the solution cup is on the cup cover bracket, attached with the reference electrode and the auxiliary electrode. The mechanical arm injects and suctions a test solution, and transfers the working electrode test piece between the test piece tray and the test piece pallet and/or transfers the cup cover between the cup cover bracket and the solution cup.

### CROSS REFERENCE TO RELATED APPLICATION

This application claims priority to Chinese Patent Application No. 202410833245.6, filed on Jun. 26, 2024, the entire content of which is incorporated herein in its entirety by reference.

### TECHNICAL FIELD

The present disclosure relates to the field of electrochemical testing technology, in particular to an electrochemical testing device.

### BACKGROUND

Electrochemical testing is one of the commonly used methods in evaluation of corrosion resistance and catalytic performance of materials, and in drug detection. Traditional electrochemical testing is a single-channel test, and the entire process is manually operated. The test process includes operations such as placing and sealing a sample and a working electrode, injecting a solution, placing a counter electrode and a reference electrode, and operating an electrochemical workstation system etc. After the sample is tested, the counter electrode and the reference electrode need to be taken out, the solution is suctioned out, and then the sample is removed, so as to complete the entire test process.

All the operations in the above traditional test method are manually operated. Due to a large number of processes, a long test cycle and cumbersome testing, there are disadvantages as follows. First, a tester needs to spend a lot of time on repetitive works and cannot concentrate on the test setting and the test result analysis. Second, different manual operations have additional influence on the test result. Third, it is not conducive to a precise control of a test time, and in a long-cycle and multi-sample testing process, it is easy to forget the test time and miss a test.

Meanwhile, in the testing device for the traditional test method, a test piece is pressed tightly by manual bolt pressing, which is inefficient and may result in poor sealing and liquid leakage caused by uneven bolt force.

Moreover, in the testing device for the traditional test method, the fixing manner of the counter electrode and the reference electrode is relatively random, which may easily lead to an inaccurate test result.

### SUMMARY

The present disclosure provides an electrochemical testing device, including: a working platform, where a mechanical arm, a test piece tray, a cup cover bracket and an electrochemical testing assembly are mounted on the working platform;
the electrochemical testing assembly includes a solution cup, a reference electrode, an auxiliary electrode, a working electrode test piece, a telescopic test piece pallet and a liftable columnar copper wire, the solution cup includes a liquid through hole at a bottom of the solution cup, a test solution in the solution cup is in contact with the working electrode test piece carried on the test piece pallet through the liquid through hole, and the columnar copper wire is configured to lift up the working electrode test piece when the columnar copper wire rises, so that the working electrode test piece is pressed and sealed on the liquid through hole;
a cup cover of the solution cup is placed on the cup cover bracket, and the reference electrode and the auxiliary electrode are mounted on the cup cover; and
the mechanical arm is configured to inject the test solution into the solution cup and suction the test solution from the solution cup, and the mechanical arm is further configured to switch and transfer the working electrode test piece between the test piece tray and the test piece pallet and/or to switch and transfer the cup cover between the cup cover bracket and the solution cup.

In an optional embodiment, the electrochemical testing assembly includes a plurality of solution cups and a plurality of cup covers, the plurality of solution cups and the plurality of cup covers constitute a plurality of test containers of the electrochemical testing assembly, the plurality of test containers share a same mechanical arm, and the mechanical arm is provided with a servo gripper configured to grab the working electrode test piece and the cup cover.

In an optional embodiment, a liquid injection short tube configured to inject the test solution and a liquid suction short tube configured to suction the test solution are fixedly mounted on the mechanical arm, and the liquid injection short tube and the liquid suction short tube extend into the solution cup under a driving of the mechanical arm.

In an optional embodiment, an internal of the working platform is provided with a liquid suction and injection system, the liquid suction and injection system includes a liquid injection assembly and a liquid suction assembly, a liquid injection hose is connected between the liquid injection assembly and the liquid injection short tube, a liquid suction hose is connected between the liquid suction assembly and the liquid suction short tube, the liquid injection hose and the liquid suction hose are penetrated mounted in an internal of the mechanical arm, and a check valve is mounted on each of the liquid injection hose and the liquid suction hose.

In an optional embodiment, the solution cup is fixed on a solution cup positioning seat, the solution cup positioning seat is provided on a table top of the working platform, the test piece pallet is provided on a side of a bottom of the solution cup positioning seat in a translatable and telescopic manner, and the solution cup and the test piece pallet are in one-to-one correspondence.

In an optional embodiment, the solution cup positioning seat includes a long-strip-shaped base, the solution cups are evenly spaced in a length direction of the solution cup positioning seat, the cup cover bracket includes a bracket with a long-strip-shaped structure, a plurality of positioning holes are provided on the bracket, a solution beaker configured to contain an electrode impregnation solution is provided on each of the positioning holes, the cup cover is provided corresponding to the solution beaker, the solution cup positioning seat extends parallel to the cup cover bracket, and the solution beaker is opposite to the solution cup.

In an optional embodiment, the electrochemical testing assembly further includes a plurality of columnar copper wire lifting mechanisms and a plurality of test piece pallet push-pull mechanisms, and the plurality of columnar copper wire lifting mechanisms and the plurality of test piece pallet push-pull mechanisms are provided corresponding to the plurality of test containers;
the columnar copper wire lifting mechanism is configured to lift up the columnar copper wire, so that the working electrode test piece is pressed on the liquid through hole of the solution cup, and the columnar copper wire lifting mechanism is further configured to lower the columnar copper wire, so that the working electrode test piece is not pressed on the solution cup; and
the test piece pallet push-pull mechanism is configured to extend and retract the test piece pallet, so that the test piece pallet is extended, retracted and translated relative to the solution cup and the working electrode test piece is taken and placed at different positions.

In an optional embodiment, the columnar copper wire lifting mechanism includes a lifting push rod and a lifting support, and the lifting support is lifted up and lowered under a driving of the lifting push rod;
the columnar copper wire is mounted on the lifting support and placed below the test piece pallet, the test piece pallet is provided with a groove configured to place the working electrode test piece, and the groove is provided with a through hole for the columnar copper wire to pass through;
the liquid through hole includes a liquid channel, the liquid channel is a straight-through structure penetrating a bottom wall of the solution cup, a sealing ring is provided at a periphery of a bottom of the liquid channel, and a bottom wall of the sealing ring protrudes relative to the bottom wall of the solution cup;
in a state that the test piece pallet is in place, the liquid channel, the through hole and the columnar copper wire are provided concentrically;
a buffer spring is provided between the columnar copper wire and the lifting support, an accommodating cavity configured to mount the columnar copper wire is provided on a top of the lifting support, the columnar copper wire includes an inverted T-shaped structure limitedly mounted in the accommodating cavity, the buffer spring includes a compression spring, a top end of the compression spring is connected to a limiting block at a bottom of the columnar copper wire, and a bottom end of the compression spring is abutted against a cavity wall at a bottom of the accommodating cavity; and
a transfer block is provided between the solution cup positioning seat and the lifting support, a guide rail is connected to a side of the lifting support, a guide block is mounted on the transfer block, a guide groove is provided on the guide block, and the guide rail is provided in cooperation with the guide groove.

In an optional embodiment, the test piece pallet push-pull mechanism includes a telescopic push rod, the test piece pallet is connected to the telescopic push rod, the telescopic push rod is provided on a side of the solution cup positioning seat close to the cup cover bracket, and a side of the telescopic push rod is provided with a photoelectric switch configured to limit a telescopic path of the telescopic push rod.

In an optional embodiment, the test piece tray includes a plurality of positioning grooves, a number of the positioning grooves corresponds to a number of the test containers, a support bar is provided on the positioning grooves, and the support bar is shared and bridged over the positioning grooves to carry and place the working electrode test piece.

Other features and advantages of the present disclosure will be described in detail in the following section of detailed description of embodiments.

### BRIEF DESCRIPTION OF THE DRAWINGS

In order to more clearly illustrate the technical solutions of the embodiments of the present disclosure, a brief introduction of the drawings required for the embodiments is made as follows. It should be understood that the following drawings only show certain embodiments of the present disclosure and should not be regarded as limiting the scope of the present disclosure. For those ordinary skilled in the art, other relevant drawings may also be obtained based on these drawings without exerting any creative effort.

FIG. 1 is a schematic diagram of a front view structure of an electrochemical testing device in the present disclosure;
FIG. 2 is a schematic diagram of a side view structure of the electrochemical testing device in the present disclosure;
FIG. 3 is a schematic diagram of a top view structure of the electrochemical testing device in the present disclosure;
FIG. 4 is a schematic diagram of an external side view structure of an electrochemical testing assembly;
FIG. 5 is a schematic diagram of an external top view structure of the electrochemical testing assembly; and
FIG. 6 is a schematic diagram of an internal sectional structure of the electrochemical testing assembly.

### REFERENCE NUMERALS

1—working platform; 11—mechanical arm; 11a—servo gripper; 11b—liquid injection short tube; 11c—liquid suction short tube; 12—test piece tray; 12a—positioning groove; 12b—support bar; 13—cup cover bracket; 13a—positioning hole; 13b—solution beaker; 14—solution cup positioning seat;
2—electrochemical testing assembly;
21—solution cup; 21a—liquid through hole; 21b—liquid channel; 21c—sealing ring;
22—test piece pallet; 22a—groove; 22b—through hole;
23—columnar copper wire;
3—cup cover; 31—reference electrode; 32—auxiliary electrode;
4—liquid suction and injection system;
5—columnar copper wire lifting mechanism; 51—lifting push rod; 52—lifting support; 53—buffer spring; 54—accommodating cavity; 55—transfer block; 56—guide rail; 57—guide block;
6—test piece pallet push-pull mechanism; 61—telescopic push rod; 62—photoelectric switch.

### DETAILED DESCRIPTION OF EMBODIMENTS

In order to make purposes, technical solutions and advantages of the embodiments of the present disclosure clearer, the technical solutions in the embodiments of the present disclosure will be clearly and completely described below in combination with the drawings in the embodiments of the present disclosure. Obviously, the described embodiments are a portion of the embodiments of the present disclosure, not all of the embodiments. The components of the embodiments of the present disclosure described and shown in the drawings here may be arranged and designed in various different configurations.

In the description of the present disclosure, it should be noted that the orientation or position relationship indicated by the terms “inside” and “outside” is an orientation or position relationship shown based on the drawings, or an orientation or position relationship in which the product of the present disclosure is usually placed when it is used. It is only used for the convenience of describing the present disclosure and simplifying the description, and it is not indicated or implied that the device or element referred to must have a specific orientation and must be constructed and operated in a specific orientation, and therefore it may not be understood as a limitation on the present disclosure. In addition, the terms, such as “first” and “second”, are only used to distinguish the description, and may not be understood as indicating or implying relative importance.

In the description of the present disclosure, it should also be noted that, unless otherwise clearly specified and defined, the terms “setting” and “connection” should be understood in a broad sense, for example, it may be a fixed connection, a detachable connection, or an integral connection, and it may be a direct connection, an indirect connection through an intermediate medium, or an internal connection of two elements. Those ordinary skilled in the art may understand the specific meanings of the above terms in the present disclosure according to specific circumstances.

The objective of the present disclosure is to provide an electrochemical testing device, which may reduce manual operations and reduce the influence of manual operations on the test result while ensuring the reliability in the test process, thereby improving the accuracy of the test result.

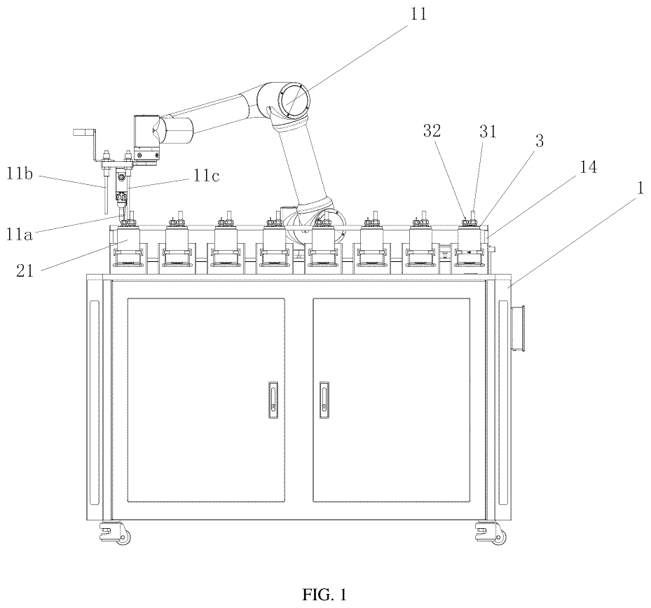

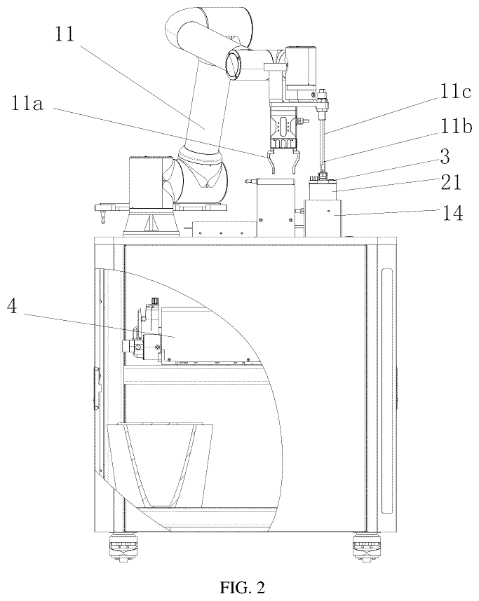

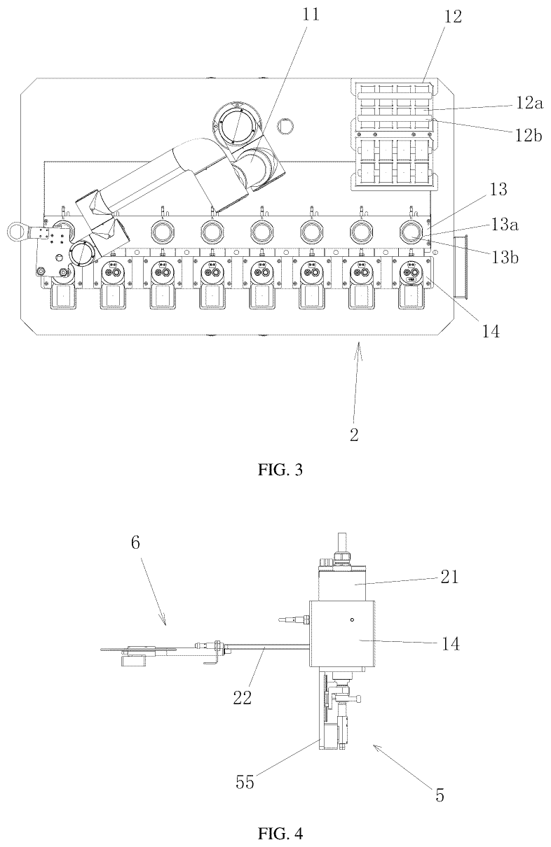

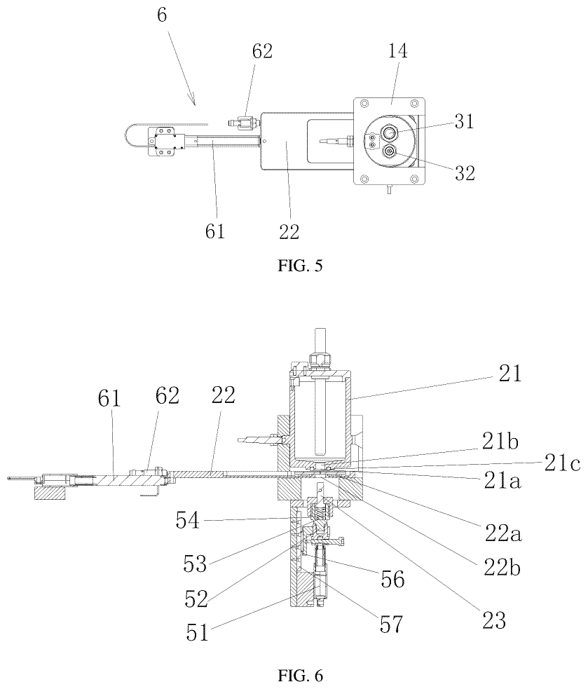

Referring to FIG. 1 to FIG. 3 in combination with FIG. 2 to FIG. 6, an electrochemical testing device in the present disclosure is mainly used for an automatic operation of the electrochemical test. Specifically, by setting a structural form of a mechanical arm 11 and improving an electrochemical testing assembly 2, the automatic operation of the mechanical arm 11 may be achieved and the accuracy of the test result is ensured.

A main structure of the electrochemical testing device in the present disclosure includes a working platform 1, and a mechanical arm 11, a test piece tray 12, a cup cover bracket 13 and an electrochemical testing assembly 2 are mounted on the working platform 1.

The electrochemical testing assembly 2 includes a solution cup 21 fixedly mounted on the working platform 1, a reference electrode 31 and an auxiliary electrode 32 mounted on a cup cover 3, a working electrode test piece, a telescopic test piece pallet 22 provided on a side of the solution cup 21, and a liftable columnar copper wire 23 located below the solution cup 21.

The cup cover 3 for covering the solution cup 21 is placed on the cup cover bracket 13, and the reference electrode 31 and the auxiliary electrode 32 are fixedly attached on the cup cover 3.

In a specific test process, the test piece pallet 22 carries a working electrode test piece (not shown in the drawings). The working electrode test piece is lifted up by the rise of the columnar copper wire 23, so that the working electrode test piece is in contact with a test solution in the solution cup 21. Combining that the cup cover 3 attached with the reference electrode 31 and the auxiliary electrode 32 is covered on a top of the solution cup 21, the reference electrode 31 and the auxiliary electrode 32 are immersed in the test solution in the solution cup 21, so that the electrochemical test operation is performed.

The solution cup 21 includes a liquid through hole 21a at the bottom of the solution cup 21. The liquid through hole 21a is mainly used to make the test solution in the solution cup 21 be in contact with the working electrode test piece carried on the test piece pallet 22. Before the test solution is injected, the columnar copper wire 23 rises through a lifting mechanism, and the working electrode test piece carried on the test piece pallet 22 is lifted up by the columnar copper wire 23, so that the working electrode test piece is sealed and pressed at the bottom of the liquid through hole 21a while being separated from the test piece pallet 22. Then, the test solution is injected into the solution cup 21 through a liquid injection tube carried by the mechanical arm 11, so as to achieve the premise of a contact between the working electrode test piece and the test solution. Afterwards, the reference electrode 31 and the auxiliary electrode 32 are immersed in the test solution to achieve an automatic conduction of a columnar copper wire 23 test circuit.

The mechanical arm 11 is mainly used to transfer the working electrode test piece and the cup cover 3, to inject the test solution during the transfer process, and to suction the test solution after the test is completed.

Specifically, the mechanical arm 11 is used to inject the test solution into the solution cup 21 and suction the test solution from the solution cup 21. The mechanical arm 11 is further used to switch and transfer the working electrode test piece between the test piece tray 12 and the test piece pallet 22 and/or switch and transfer the cup cover 3 between the cup cover bracket 13 and the solution cup 21, thereby achieving an automatic operation.

In a specific embodiment, the electrochemical testing device is specifically a high-throughput electrochemical testing device. The electrochemical testing device includes a plurality of solution cups 21 and a plurality of cup covers 3. The plurality of solution cups 21 and the plurality of cup covers 3 constitute a plurality of test containers of the electrochemical testing assembly 2. In a specific operation process, the test solution may be injected into the plurality of test containers in sequence for testing to improve the testing efficiency.

In order to give full play to the automatic operation function of the mechanical arm 11, the plurality of the test containers share the same mechanical arm 11. The mechanical arm 11 is provided with a servo gripper 11a for grabbing the working electrode test piece and the cup cover 3.

Specifically, the mechanical arm 11 in the present disclosure mainly includes two functions. The first main function of the mechanical arm 11 is to grab and transfer the working electrode test piece and the cup cover 3 through the servo gripper 11a.

Regarding to the transfer of the working electrode test piece, the working electrode test piece is transferred between the test piece tray 12 and the test piece pallet 22. Before the test, the working electrode test piece is transferred from the test piece tray 12 to the test piece pallet 22 through the servo gripper 11a, and then the working electrode test piece is lifted up by the columnar copper wire 23. After the test is completed, the working electrode test piece is reset to the test piece pallet 22 by lowering the columnar copper wire 23, the test piece pallet 22 is pushed outward, and then the working electrode test piece is transferred back to the test piece tray 12 through the mechanical arm 11.

Regarding to the transfer of the cup cover 3, after the test solution is injected into the solution cup 21, the cup cover 3 is clamped from the cup cover bracket 13 and transferred onto the solution cup 21. After the test is completed, the cup cover 3 is transferred from the solution cup 21 and reset onto the cup cover bracket 13.

The second main function of the mechanical arm 11 is to inject the test solution, and to suction the test solution after the test is completed. After the working electrode test piece is lifted up and pressed to the bottom of the solution cup 21 through the columnar copper wire 23, the mechanical arm 11 moves to a position above the solution cup 21, injects the test solution into the solution cup 21, and then transfers the cup cover 3 to cover the solution cup 21.

After the test is completed, the mechanical arm 11 transfers the cup cover 3, moves to the position above the solution cup 21 again, and suctions the test solution in the solution cup 21. After the solution cup 21 is suctioned to be empty, the columnar copper wire 23 is lowered, and the columnar copper wire 23 drives the working electrode test piece not to press and seal the solution cup 21.

Specifically, the injection and the suction of the test solution by the mechanical arm 11 are respectively performed through a liquid injection short tube 11b and a liquid suction short tube 11c fixedly mounted on the mechanical arm 11. The liquid injection short tube 11b and the liquid suction short tube 11c may extend into the solution cup 21 under the driving of the mechanical arm 11 to complete the injection and suction operations respectively.

Furthermore, an internal of the working platform 1 is provided with a liquid suction and injection system 4, and the liquid suction and injection system 4 includes a liquid injection assembly and a liquid suction assembly.

A liquid injection hose is connected between the liquid injection assembly and the liquid injection short tube 11b, and a liquid suction hose is connected between the liquid suction assembly and the liquid suction short tube 11c. The liquid injection hose and the liquid suction hose are penetrated mounted in an internal of the mechanical arm 11. The setting of the hoses may overcome the space limitation of the mechanical arm 11 in the movement process, and may maintain a connection relationship between the liquid injection assembly and the liquid injection short tube 11b and a connection relationship between the liquid suction assembly and the liquid suction short tube 11c.

In order to prevent backflow, a check valve is mounted on each of the liquid injection hose and the liquid suction hose, which defines a unidirectional flowability of the test solution during the injection and suction processes to ensure the reliability of operations

In another specific embodiment, the solution cup 21 is fixed on a solution cup positioning seat 14, and the solution cup positioning seat 14 is provided on a table top of the working platform 1, which mainly plays a good limiting and fixing role on the solution cup 21.

On the basis that the working electrode test piece is lifted up and pressed at the bottom of the solution cup 21, the test piece pallet 22 may be provided on a side of the bottom of the solution cup positioning seat 14 in a translatable and telescopic manner, so that the working electrode test piece may be translated directly below the solution cup 21 when the working electrode test piece is carried on the test piece pallet 22. In order to avoid affecting each other, the solution cup 21 and the test piece pallet 22 are in one-to-one correspondence, so that different working electrode test pieces correspond to different test containers.

In a case that the electrochemical testing device includes the plurality of solution cups 21 and the plurality of cup covers 3, the solution cup positioning seat 14 includes a long-strip-shaped base, and the solution cups 21 are evenly spaced in a length direction of the solution cup positioning seat 14.

The cup cover bracket 13 includes a bracket with a long-strip-shaped structure, and a plurality of positioning holes 13a are provided on the bracket. A solution beaker 13b for containing an electrode impregnation solution is provided on each of the positioning holes 13a.

The electrode impregnation solution in the solution beaker 13b may effectively protect the reference electrode 31 and the auxiliary electrode 32, so that the reference electrode 31 and the auxiliary electrode 32 in each test container are placed in a unified and regulated manner, thereby ensuring the accuracy and authenticity of the test result.

In a specific arrangement form, the cup cover 3 is provided corresponding to the solution beaker 13b. Preferably, each cup cover 3 is placed on a corresponding solution beaker 13b, and the electrode impregnation solution in each solution beaker 13b maintains a same composition state.

The solution cup positioning seat 14 extends parallel to the cup cover bracket 13, and the solution beaker 13b is opposite to the solution cup 21. Furthermore, each solution beaker 13b corresponds to each solution cup 21 in a front-back direction, which is conducive to the positioning and transfer of the mechanical arm 11.

The corresponding action relationship between the columnar copper wire 23 and the working electrode test piece, and the front-back telescopic action relationship of the working electrode test piece relative to the solution cup 21 are described above.

The electrochemical testing assembly 2 includes a plurality of columnar copper wire lifting mechanisms 5 and a plurality of test piece pallet push-pull mechanisms 6, which are provided corresponding to the plurality of test containers. In this embodiment, the electrochemical testing assembly 2 includes 8 columnar copper wire lifting mechanisms 5, 8 test piece pallet push-pull mechanisms 6 and 8 test containers, which is conducive to achieving high-throughput test operations.

In the specific operation process, the columnar copper wire lifting mechanism 5 is used to lift up and lower the columnar copper wire 23. In this way, the columnar copper wire 23 may be lifted up to press the working electrode test piece on the liquid through hole 21a of the solution cup 21 before the test, and the columnar copper wire 23 may be lowered so that the working electrode test piece is not pressed on the solution cup 21 after the test.

The test piece pallet push-pull mechanism 6 is used to extend and retract the test piece pallet 22, so that the test piece pallet 22 may be extended, retracted and translated relative to the solution cup 21 and the working electrode test piece may be taken and placed at different positions.

There are mainly two positions of the test piece pallet 22 relative to the solution cup 21. One state is that the test piece pallet 22 extends forward to a side of the solution cup 21, which is mainly used for the placement and reset recovery of the working electrode test piece by the mechanical arm 11.

The other state is that the test piece pallet 22 is located directly below the solution cup 21, so that in the lifting and lowering processes of the columnar copper wire 23, the working electrode test piece is pressed and sealed at the bottom of the solution cup 21 before the test, and the working electrode test piece is reset and carried on the test piece pallet 22 after the test.

In terms of the specific composition and structure, the columnar copper wire lifting mechanism 5 includes a lifting push rod 51 and a lifting support 52, and the lifting support 52 may be lifted up and lowered under the driving of the lifting push rod 51.

The columnar copper wire 23 is mounted on the lifting support 52 and provided below the test piece pallet 22. The test piece pallet 22 is provided with a groove 22a for placing the working electrode test piece, and the groove 22a is provided with a through hole 22b for the columnar copper wire 23 to pass through. The columnar copper wire 23 and the through hole 22b have a clearance fit relationship, so that the working electrode test piece may be lifted up and lowered by the columnar copper wire 23 under the lifting and lowering driving of the lifting support 52.

The liquid through hole 21a includes a liquid channel 21b, which is a straight-through structure penetrating a bottom wall of the solution cup 21. A sealing ring 21c is provided at a periphery of the bottom of the liquid channel 21b. A bottom wall of the sealing ring 21c protrudes relative to the bottom wall of the solution cup 21, so that a top surface of the working electrode test piece and the sealing ring 21c may maintain a reliable pressing and sealing relationship to avoid liquid leakage.

Preferably, the bottom wall of the solution cup 21 includes a lower conical surface structure, and the liquid channel 21b is provided at a cone bottom of the lower conical surface structure. In the injection process, an end of the liquid injection short tube 11b is inserted into the liquid channel 21b, so that the test solution may be in contact with the pressed and sealed working electrode test piece quickly.

In the suction process, an end of the liquid suction short tube 11c is inserted into the liquid channel 21b to achieve a full and complete suction of the test solution.

In order to facilitate lifting the working electrode test piece by the columnar copper wire 23 while separating the working electrode test piece from the test piece pallet 22, in a state that the test piece pallet 22 is in place, i.e., in a state that the working electrode test piece is carried on the test piece pallet 22 and the test is performed immediately, the liquid channel 21b, the through hole 22b and the columnar copper wire 23 are concentrically provided to ensure the accuracy of the columnar copper wire 23 in the lifting and lowering processes. Vice versa, the same relationship exists in the lowering process of the working electrode test piece.

Based on the pressing and sealing of the working electrode test piece at the bottom of the solution cup 21 by the columnar copper wire 23, a buffer spring 53 is provided between the columnar copper wire 23 and the lifting support 52 to prevent the lifting push rod 51 from being overloaded.

Furthermore, an accommodating cavity 54 for mounting the columnar copper wire 23 is provided on the top of the lifting support 52. The columnar copper wire 23 includes an inverted T-shaped structure limitedly mounted in the accommodating cavity 54, and the columnar copper wire 23 has a certain relative amount of movement in the accommodating cavity 54.

The buffer spring 53 includes a compression spring. A top end of the compression spring is connected to a limiting block at the bottom of the columnar copper wire 23, and a bottom end of the compression spring is abutted against a cavity wall at the bottom of the accommodating cavity 54. In this way, the compression spring has a good buffering effect. Under the premise of ensuring the reliable and stable pressing and sealing of the columnar copper wire 23, the lifting overload of the working electrode test piece is reduced by using the compression spring, which effectively protects the structure of the working electrode test piece and prevents liquid leakage caused by a break of the working electrode test piece.

From the perspective of ensuring a reliable lifting and lowering, a transfer block 55 is provided between the solution cup positioning seat 14 and the lifting support 52, a guide rail 56 is connected to a side of the lifting support 52, a guide block 57 is mounted on the transfer block 55, and a guide groove is provided on the guide block 57. The guide rail 56 is provided in cooperation with the guide groove, so that the columnar copper wire 23 may be lifted up and lowered along a straight line, thereby ensuring an effective and reliable pressing of the working electrode test piece.

From the perspective that the test piece pallet 22 is telescopic forward and backward, the test piece pallet push-pull mechanism 6 includes a telescopic push rod 61, and the test piece pallet 22 is connected to the telescopic push rod 61. The telescopic push rod 61 is provided on a side of the solution cup positioning seat 14 close to the cup cover bracket 13. The telescopic push rod 61 may push the test piece pallet 22 outward relative to the solution cup positioning seat 14, so as to expose the test piece pallet 22, which is conducive to taking and placing the working electrode test piece by the mechanical arm 11.

It should be pointed out that a retracted state of the telescopic push rod 61 corresponds to a state in which the through hole 22b on the test piece pallet 22 is located directly between the liquid through hole 21a and the columnar copper wire 23, so as to perform the test operation in the retracted state of the telescopic push rod 61, thereby facilitating management and control.

Both the lifting push rod 51 and the telescopic push rod 61 in this embodiment are electric push rods. A side of the telescopic push rod 61 is provided with a photoelectric switch 62 for limiting a telescopic path of the telescopic push rod 61. The photoelectric switch 62 is mainly used to sense forward and backward telescopic positions of the test piece pallet 22 for positioning the test piece pallet 22, so as to meet the application requirements of precise positioning control.

The test piece tray 12 includes a plurality of positioning grooves 12a, and the number of the positioning grooves 12a corresponds to the number of the test containers. A support bar 12b is provided on the positioning grooves 12a, and the support bar 12b is shared and bridged over the positioning grooves 12a to carry and place the working electrode test piece.

The positioning grooves 12a are mainly used to cooperate with the mechanical arm 11, so as to achieve that the mechanical arm 11 positions and clamps the working electrode test piece placed on the test piece tray 12. The working electrode test piece may be conveniently placed on the support bar 12b, so as to ensure that the mechanical arm 11 stably and smoothly clamps the working electrode test piece.

The electrochemical testing device in the present disclosure is mainly a high-throughput electrochemical testing device including a plurality of test containers. The mechanical arm 11 is combined with the execution structures included in the electrochemical testing assembly 2 to achieve the automatic operation of the electrochemical test, where the mechanical arm 11 is used to achieve the operations of taking and placing the working electrode test piece, injecting and suctioning the test solution, and immersing and resetting the reference electrode 31 and the auxiliary electrode 32, and the execution structures included in the electrochemical testing assembly 2 are used to lift up and lower the columnar copper wire 23 and switch the working electrode test piece among different position states. In this way, the accuracy of the test result may be ensured in relatively normalized objective conditions, thereby improving the test efficiency substantially.

In the implementation process, an internal of the working platform 1 is a steel structure welded frame, an external of the working platform 1 is an outer shell made of sheet metal, and a top panel of the working platform 1 is made of chrome-plated steel plate, which is mainly used for positioning and mounting other devices.

The mechanical arm 11 adopts a standard collaborative robot with a load of 5 Kg and an arm span of 850 mm. The servo gripper 11a and the liquid suction and injection tubes are mounted at the end of the mechanical arm 11. The mechanical arm 11 drives the servo gripper 11a and the liquid suction and injection tubes at the end to complete the working processes of grabbing the working electrode test piece, grabbing the cup cover, injecting the liquid and suctioning the liquid.

The test piece tray 12 is fabricated according to the shape of the working electrode test piece, and has a built-in chip for positioning the working electrode test piece.

Various parts of the electrochemical testing assembly 2 work in a predetermined order to complete the functions of injecting the solution, pressing the working electrode test piece, immersing the working electrode test piece, and connecting the columnar copper wire 23 test circuit, etc.

The cup cover bracket 13 is made of aluminum profile, which may accurately locate the position of the cup cover, and facilitates taking and placing operations of the mechanical arm 11. Meanwhile, after the solution beaker 13b is placed on each positioning hole 13a and the cup cover is placed into the positioning groove, the reference electrode 31 and the auxiliary electrode 32 are inserted into the electrode impregnation solution to keep the electrodes moist.

The liquid injection assembly and the liquid suction assembly include a solution tank, a waste liquid tank, a quantitative peristaltic pump and a gear pump. The quantitative peristaltic pump is used to inject the solution into the solution cup 21, and the gear pump is used to suction the solution from the solution cup 21.

Manual operations during the test process may be reduced through the electrochemical testing device of the present disclosure. Transfer of the working electrode test piece, injection and suction of the test solution, and installation of the cup cover on the solution cup may be achieved through the mechanical arm.

Combined with the liftable columnar copper wire, the working electrode test piece may be lifted, pressed and sealed on the liquid through hole at the bottom of the solution cup to avoid liquid leakage caused by poor sealing.

The columnar copper wire may automatically conduct the test circuit through the contact between the working electrode test piece in the lifted state and the test solution via the liquid through hole and the pressing contact between the columnar copper wire and the working electrode test piece, thereby achieving the automatic testing.

The reference electrode and the auxiliary electrode attached on the cup cover may be in contact with the test solution after the cup cover is placed on the solution cup, so that the fixing manner of the reference electrode and the auxiliary electrode is normalized, thereby effectively ensuring the accuracy of the test result.

The present disclosure further provides an electrochemical testing method, including the following steps (1) to (12).
(1) A tester places the solution cup 21 on the solution cup positioning seat 14, places the working electrode test piece on the test piece tray 12, sets test parameters on an operating screen of an operating system, and then presses a Start button to start the test;
(2) The mechanical arm 11 clamps the working electrode test piece from the test piece tray 12 and transfers the working electrode test piece to the test piece pallet 22;
(3) The test piece pallet 22 moves to the internal of the electrochemical testing assembly 2, so that the through hole 22b is concentric with the liquid through hole 21a of the solution cup 21;
(4) The lifting push rod 51 pushes the lifting support 52 to rise, so that the columnar copper wire 23 lifts the working electrode test piece and presses the working electrode test piece on the sealing ring 21c at the bottom of the solution cup 21;
(5) The mechanical arm 11 moves to the position above the solution cup 21, and quantitatively injects the test solution into the internal of the solution cup 21 through the liquid injection short tube 11b;
(6) The mechanical arm 11 clamps the cup cover 3 from the cup cover bracket 13 and places the cup cover 3 on the solution cup 21;
(7) Actions are repeated on the remaining 7 stations, and the immersion process starts;
(8) When the immersion time is up, the detection devices are switched on respectively to collect and record the test data;
(9) The mechanical arm 11 removes the cup cover 3 and places the cup cover 3 into the positioning groove of the cup cover bracket 13;
(10) The mechanical arm 11 moves to the position above the solution cup 21, and extends the liquid suction short tube 11c into the liquid channel 21b at the bottom of the cup to completely suction the test solution;
(11) The lifting push rod 51 lowers, and the telescopic push rod 61 extends;
(12) The mechanical arm 11 grabs the working electrode test piece and places the working electrode test piece into the test piece tray 12 to complete the test.

Compared with the previous testing device, the main advantage of the electrochemical testing device in the present disclosure is the automation of the test process, which improves the test efficiency and accuracy.

In order to achieve the objective of automatic operations, the core testing device is redesigned, so that the actions that previously required manual operations are changed to be automatic operations. The specific technical effects are reflected in the following aspects (1) to (6)
(1) An electric push rod is used to automatically press the working electrode test piece tightly and automatically move the working electrode test piece;
(2) The lifting and pressing mechanism is provided with a buffer spring 53 to prevent the electric push rod from being overloaded;
(3) The columnar copper wire 23 is mounted at the top of the lifting and pressing mechanism to achieve an automatic connection of the test circuit;
(4) A reliable positioning of an automatic pressing may be achieved through the mutual cooperation between the solution cup 21 and the solution cup positioning seat 14;
(5) The setting of the cup cover 3 facilitates grabbing by the mechanical arm 11 and achieves an accurate positioning of the reference electrode 31 and the auxiliary electrode 32;
(6) The mechanical arm 11 may complete the entire action process through programming.

It should be noted that, in the absence of conflict, the features in the embodiments of the present disclosure may be combined with each other.

The above is only preferred embodiments of the present disclosure and is not intended to limit the present disclosure. For those skilled in the art, the present disclosure may have various modifications and variations. Any modifications, equivalent substitutions, improvements, etc. made within the spirit and principle of the present disclosure should be included in the protection scope of the present disclosure.

What is claimed is:

1. An electrochemical testing device, comprising:
a working platform, wherein a mechanical arm, a test piece tray, a cup cover bracket and an electrochemical testing assembly are mounted on the working platform;
wherein the electrochemical testing assembly comprises a solution cup, a reference electrode, an auxiliary electrode, a working electrode test piece, a telescopic test piece pallet and a liftable columnar copper wire, the solution cup comprises a liquid through hole at a bottom of the solution cup, a test solution in the solution cup is in contact with the working electrode test piece carried on the test piece pallet through the liquid through hole, and the columnar copper wire is configured to lift up the working electrode test piece when the columnar copper wire rises, so that the working electrode test piece is pressed and sealed on the liquid through hole;
wherein a cup cover of the solution cup is placed on the cup cover bracket, and the reference electrode and the auxiliary electrode are mounted on the cup cover; and
wherein the mechanical arm is configured to inject the test solution into the solution cup and suction the test solution from the solution cup, and the mechanical arm is further configured to switch and transfer the working electrode test piece between the test piece tray and the test piece pallet and/or to switch and transfer the cup cover between the cup cover bracket and the solution cup.

2. The electrochemical testing device according to claim 1, wherein the electrochemical testing assembly comprises a plurality of solution cups and a plurality of cup covers, the plurality of solution cups and the plurality of cup covers constitute a plurality of test containers of the electrochemical testing assembly, the plurality of test containers share a same mechanical arm, and the mechanical arm is provided with a servo gripper configured to grab the working electrode test piece and the cup cover.

3. The electrochemical testing device according to claim 1, wherein a liquid injection short tube configured to inject the test solution and a liquid suction short tube configured to suction the test solution are fixedly mounted on the mechanical arm, and the liquid injection short tube and the liquid suction short tube extend into the solution cup under a driving of the mechanical arm.

4. The electrochemical testing device according to claim 3, wherein an internal of the working platform is provided with a liquid suction and injection system, the liquid suction and injection system comprises a liquid injection assembly and a liquid suction assembly, a liquid injection hose is connected between the liquid injection assembly and the liquid injection short tube, a liquid suction hose is connected between the liquid suction assembly and the liquid suction short tube, the liquid injection hose and the liquid suction hose are penetrated mounted in an internal of the mechanical arm, and a check valve is mounted on each of the liquid injection hose and the liquid suction hose.

5. The electrochemical testing device according to claim 2, wherein the solution cup is fixed on a solution cup positioning seat, the solution cup positioning seat is provided on a table top of the working platform, the test piece pallet is provided on a side of a bottom of the solution cup positioning seat in a translatable and telescopic manner, and the solution cup and the test piece pallet are in one-to-one correspondence.

6. The electrochemical testing device according to claim 5, wherein the solution cup positioning seat comprises a long-strip-shaped base, the solution cups are evenly spaced in a length direction of the solution cup positioning seat, the cup cover bracket comprises a bracket with a long-strip-shaped structure, a plurality of positioning holes are provided on the bracket, a solution beaker configured to contain an electrode impregnation solution is provided on each of the positioning holes, the cup cover is provided corresponding to the solution beaker, the solution cup positioning seat extends parallel to the cup cover bracket, and the solution beaker is opposite to the solution cup.

7. The electrochemical testing device according to claim 5, wherein the electrochemical testing assembly further comprises a plurality of columnar copper wire lifting mechanisms and a plurality of test piece pallet push-pull mechanisms, and the plurality of columnar copper wire lifting mechanisms and the plurality of test piece pallet push-pull mechanisms are provided corresponding to the plurality of test containers;
wherein the columnar copper wire lifting mechanism is configured to lift up the columnar copper wire, so that the working electrode test piece is pressed on the liquid through hole of the solution cup, and the columnar copper wire lifting mechanism is further configured to lower the columnar copper wire, so that the working electrode test piece is not pressed on the solution cup; and
wherein the test piece pallet push-pull mechanism is configured to extend and retract the test piece pallet, so that the test piece pallet is extended, retracted and translated relative to the solution cup and the working electrode test piece is taken and placed at different positions.

8. The electrochemical testing device according to claim 7, wherein the columnar copper wire lifting mechanism comprises a lifting push rod and a lifting support, and the lifting support is lifted up and lowered under a driving of the lifting push rod;
wherein the columnar copper wire is mounted on the lifting support and placed below the test piece pallet, the test piece pallet is provided with a groove configured to place the working electrode test piece, and the groove is provided with a through hole for the columnar copper wire to pass through;
wherein the liquid through hole comprises a liquid channel, the liquid channel is a straight-through structure penetrating a bottom wall of the solution cup, a sealing ring is provided at a periphery of a bottom of the liquid channel, and a bottom wall of the sealing ring protrudes relative to the bottom wall of the solution cup;
wherein in a state that the test piece pallet is in place, the liquid channel, the through hole and the columnar copper wire are provided concentrically;
wherein a buffer spring is provided between the columnar copper wire and the lifting support, an accommodating cavity configured to mount the columnar copper wire is provided on a top of the lifting support, the columnar copper wire comprises an inverted T-shaped structure limitedly mounted in the accommodating cavity, the buffer spring comprises a compression spring, a top end of the compression spring is connected to a limiting block at a bottom of the columnar copper wire, and a bottom end of the compression spring is abutted against a cavity wall at a bottom of the accommodating cavity; and
wherein a transfer block is provided between the solution cup positioning seat and the lifting support, a guide rail is connected to a side of the lifting support, a guide block is mounted on the transfer block, a guide groove is provided on the guide block, and the guide rail is provided in cooperation with the guide groove.

9. The electrochemical testing device according to claim 7, wherein the test piece pallet push-pull mechanism comprises a telescopic push rod, the test piece pallet is connected to the telescopic push rod, the telescopic push rod is provided on a side of the solution cup positioning seat close to the cup cover bracket, and a side of the telescopic push rod is provided with a photoelectric switch configured to limit a telescopic path of the telescopic push rod.

10. The electrochemical testing device according to claim 2, wherein the test piece tray comprises a plurality of positioning grooves, a number of the positioning grooves corresponds to a number of the test containers, a support bar is provided on the positioning grooves, and the support bar is shared and bridged over the positioning grooves to carry and place the working electrode test piece.
